(19) United States
(12) Patent Application Publication
(10) Pub. No.: US 2016/0250767 A1
(43) Pub. Date: Sep. 1, 2016

(54) SLICER BLADE MADE OF PLASTICS

(71) Applicant: GEA Food Solutions Germany GmbH, Biedenkopf-Wallau (DE)

(72) Inventor: Albert Hartmann, Altusried (DE)

(21) Appl. No.: 15/030,707

(22) PCT Filed: Sep. 15, 2014
(86) PCT No.: PCT/EP2014/069605

§ 371 Date: Apr. 20, 2016

(30) Foreign Application Priority Data
Oct. 30, 2013 (DE) 102013222080.4

(51) Int. Cl. B26D 1/00; B26D 1/143

(52) U.S. Cl. CPC B26D 1/0006; B26D 1/143; B26D 2001/0026; B26D 2210/02

(57) ABSTRACT

A slicer blade which cuts foodstuff slices from a foodstuff block. The slicer blade thereby rotating about its rotation axis. The main body of the slicer blade is at least partially, preferably entirely, made of a plastics material.

### FIELD

The present invention relates to a slicer blade which cuts foodstuff slices from a foodstuff block, said slicer blade thereby rotating about its rotation axis.

### BACKGROUND

Slicer blades of this type are well known in the prior art and are fitted to slicing devices which rotatingly drive the slicer blade so that the latter can cut foodstuff slices from the front end of a foodstuff block. The foodstuff block here is conveyed in the direction of the rotating blade. These slicing devices nowadays may be embodied with multiple tracks so as to simultaneously cut off foodstuff slices from a plurality of foodstuff blocks. Since there is typically only one slicer blade employed here, the sheer blades need to be embodied in an increasingly larger manner, on account of which the weight of said slicer blades is increased. This makes handling of the slicer blades increasingly difficult both during fitting thereof as well as during the operation thereof.

### SUMMARY

It was therefore the object of the present invention to provide a slicer blade which

does not have the disadvantages of the prior art. The object is achieved by a slicer blade which cuts foodstuff slices from a foodstuff block, said slicer blade thereby rotating about its rotation axis, wherein the main body of said slicer blade is made of a plastics material.

The present invention relates to a slicer blade, a cutting blade, which cuts foodstuff slices from a foodstuff block. Foodstuffs to be sliced are, for example, sausages, cheese, or ham. To this end, the slicer blade is rotatingly drives for example at 200-2000, preferably 500-1200 revolutions per minute. One foodstuff slice may be cut off per revolution. To this end, the foodstuff block is conveyed in the direction of the sheer blade, wherein the thickness of the foodstuff slice is a result of the indexing of the foodstuff block between two cutting actions. After having been cut off, the slices typically fall onto a so-called placing table on which said slices are configured to form portions of 10 foodstuff slices, for example. In order to enable outward conveying of a portion of this type, the cutting blade, after slicing thereof, preferably performs one or two non-productive cuts during which the blade indeed rotates, preferably at unmodified revolutions, but no foodstuff slices are severed from the foodstuff block. Instead, the foodstuff block is refracted from the cutting plane and/or the cutting blade is moved out of the cutting plane, for example in that the cutting blade is moved away in a manner parallel to the rotation axis of said cutting blade. As soon as a sufficient number of non-productive cuts have been carried out, the foodstuff block is urged forward again in the direction of the cutting plane and/or the cutting blade is moved back into the cutting plane. Slicing devices nowadays preferably have a plurality of tracks which can receive a foodstuff block each. On account thereof, it is possible to cut a plurality of foodstuff slices from a plurality of foodstuff blocks in a substantially simultaneous manner with one rotation of the slicer blade.

The slicing device typically has a rotating shaft to which the slicer blade is directly or indirectly attached. To this end, the sheer blade preferably has a clearance which can receive the shaft and/or can center the slicer blade on the shall. Moreover, further clearances through which the fastening means, for example screws, may be push-fitted so as to fasten the slicer blade to the slicing device are preferably provided.

According to the invention, the sheer blade has a main body which may be provided from a solid material or may be at least partially provided as a hollow body. This main body according to the invention is now at least partially, preferably entirely made of a plastics material.

To a person skilled in the art it was astonishing and unexpected that it is possible for a sheer blade to be made from a plastics material, despite significant forces and torques on account of the rotation acting on the slicer blade when the latter enters into the foodstuff block and when the latter cuts through the foodstuff block, and/or when the slicer blade is moved for a non-productive cut.

Preferably, the main body at least in portions is provided with a coating. This here may be a metal and/or a ceramics coating, for example. The coating is preferably provided in the region of the blade edge. The coating may be applied to the main body in any manner known to a person skilled in the art. The coating is preferably applied to the main body by chemical vapor deposition, for example by sputtering.

The plastics material is preferably reinforced by a structure, in particular by fibers, particularly preferably reinforced by glass, carbon sod/or metal fibers. The plastics is a glass-fiber reinforced plastics, for example. The ingredients of the plastics body or of the resin matrix, respectively, preferably correspond to the established regulations for food contact, and/or may preferably be provided with a conforming coating.

The fibers may be oriented or non-oriented. The fibers may be distributed across the main body in a homogeneous manner. However, the fibers are preferably disposed in the plastics material in a non-uniform manner, wherein more fibers are provided in portions having comparatively high mechanical stress than in portions having comparatively low mechanical stress.

The fibers may in each case be of substantially identical length or may be of dissimilar lengths. The fibers may be woven or non-woven. Alternatively or additionally, the fibers may be interconnected by other methods, for example by felting and/or stitch-bonding.

The sheer blade may be a circular blade, a spiral blade, or a sickle blade.

Preferably, the plastics material and/or the coating have/has a means, in particular an additive, which by means of an analytical method is detectable such that a respective device may determine whether particles which are released from the sheer blade during cutting have landed in the foodstuff product. A product of this type may then be expelled. The means may be a metal powder, for example, which is particularly preferably provided as a nanopowder. Established analytical methods are an irradiation scanner, in particular an x-ray scanner, and/or a metal detector.

### BRIEF DESCRIPTION OF THE DRAWINGS

FIG. 1 shows the slicer blade.

### DETAILED DESCRIPTION

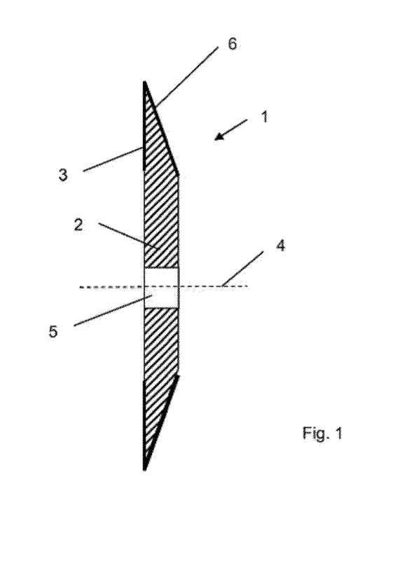

The invention will be explained hereunder by means of the only FIG. 1. These explanations are merely exemplary and do not limit the general concept of the invention.

FIG. 1 shows the slicer blade 1 according to the invention, which has a main body 2 which at least partially, here entirely, is made of a plastics material. The sheer blade 1 has a rotation axis 4 about which the sheer blade 1 rotates during slicing. A clearance 5 which serves as a receptacle for the blade shaft, and/or for a blade receptacle provided thereon, is provided in the region of the rotation axis. In the present case, the plastics of which the main body 2 is made is a glass-fiber reinforced plastics. The main body 2, here in the region of the blade edge 6, is partially provided with a coaling 3 which in the present case is composed of metal or a metal alloy. The main body 2 may be partially hollow or be made from a solid material. The fibers of the reinforcement may be distributed in a uniform or non-uniform manner. The fibers may be of a substantially identical length or may have dissimilar lengths. Moreover, the fibers may be interconnected by weaving or felting, for example.

### LIST OF REFERENCE SIGNS

1 Slicer blade

2 Main body

3 Coating

4 Rotation axis

5 Clearance

6 Blade edge

1. A slicer blade which cuts foodstuff slices from a foodstuff block, the slicer blade comprising:
a main body that is at least partially made of a plastics material,
wherein the slicer blade rotates about its rotation axis.

2. The slicer blade of claim 1, wherein the main body at least in portions is provided with a coating.

3. The slicer blade of claim 2, wherein the coating is a metal and/or ceramics coating.

4. The slicer blade of claim 2, wherein the coating is performed by chemical vapor deposition.

5. The slicer blade of claim 1, wherein the plastics material is reinforced.

6. The slicer blade of claim 4, wherein the plastics material is reinforced by fibers.

7. The slicer blade of claim 5, wherein the plastics material is reinforced by fibers that are oriented or non-oriented.

8. The slicer blade of claim 6, the fibers are woven or non-woven.

9. The slicer blade of claim 1, wherein slicer blade is a circular blade, a spiral blade, or a sickle blade.

10. The slicer blade of claim 1, wherein the slicer blade has a clearance in a region of the rotation axis.

11. The slicer blade of claim 1, wherein the main body that is entirely made of the plastics material.

12. A slicer blade comprising:
a main body that is entirely made of a plastics material, the main body comprising a blade edge,
wherein the blade edge is partially provided with the coating that is a is a metal and/or ceramics coating,
wherein the coating is performed by chemical vapor deposition,
wherein the plastics material of the main body is reinforced by fibers, and
wherein the sliver blade is a circular blade, a spiral blade, or a sickle blade.
